(19) United States
(12) Patent Application Publication
(10) Pub. No.: US 2005/0245234 A1
(43) Pub. Date: Nov. 3, 2005

(54) Antenna and headset for a wireless device

(76) Inventor: Michael Stopek, Delray Beach, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 10/833,628

(22) Filed: Apr. 28, 2004

(51) Int. Cl. H04B 1/38

(52) U.S. Cl. 455/411

(57) ABSTRACT

A cellular phone that has a wireless receiver for receiving RF signals, a wireless transmitter for transmitting RF signals and an audio input/output circuit for processing audio signals. This cellular phone and additionally a retractable combination wireless device antenna and headset have an audio conductor, a speaker conductively connected to the audio input/output circuit through the audio conductor, and an RF antenna element, coupled to the wireless receiver and the wireless transmitter. These devices further have a retractor that retracts at least a portion of the RF antenna element and at least a portion of the audio conductor from a first retracted length to a second extended length.

### FIELD OF THE INVENTION

The present invention generally relates to wireless receivers, and more particularly relates to antennas for mobile wireless receivers.

### BACKGROUND OF THE INVENTION

The use of cell telephones and other wireless voice technology has grown at a tremendous rate. Portability through small size, convenience, ease of use, are just a few of the reasons for this rapid growth.

The use of cellular telephones during certain activities, such as operating a motor vehicle, has been found to be distracting and thereby increasing the rate of traffic accidents. Many users of cellular telephone utilize hands-free connections, such as telephone headsets, when operating motor vehicles. In fact many local governments have banned the use of cellular telephones while driving without the use of hands-free devices, such as, speaker-phones and hands-free headsets. Hands-free handsets while convenient do have drawbacks. One drawback is that the user is required to remember to carry the headsets whenever needed. Another drawback to the use of headsets is that their wires and cords have a proclivity to tangle when not stored properly. Still another, drawback to the use of handsets is that their improper storage often results in the handset becoming broken.

Moreover, the user of hands-free handsets, like any other accessory requires the user to remember to bring the hands-free accessory wherever they go. This can be especially problematic if the user travels frequently and drives more than one car. In all cases, the user must remember to carry the handset.

One method users of cellular telephones utilize when requiring hands-free operation is to use speaker phones. Speaker-phones however, many times are not helpful. This is especially true if the conversation is taking place in a location where others can easily listen. Another drawback to the use of speaker phones is their poor operation in environments with background noise. Accordingly, a need exists to solve the aforementioned drawbacks of the hands-free telephone headsets and to provide a system to allow hands-free operation to be built in the telephone without the use of speaker-phones.

Now, returning to the reasons for rapid growth of cellular phone adoption is their portability. In response to consumer demand, combined with the increase availability of ever smaller internal electronic components, each year the manufacturers of cellular telephones have been able to offer cellular telephones with smaller physical dimensions. The smaller physical dimensions of cellular telephones make it easier for users to carrying a cellular telephone in a pocket, on a belt clip, and in a purse. The miniaturization of cellular telephones although useful, often times has drawbacks. One drawback is that along with the physical dimensions of the internal components, the antennas of cellular telephones are often made smaller to accommodate the smaller footprint. Many times the reduction in antenna size results in an attendant loss of reception sensitivity when receiving and transmitting voice and text and other messages over a wireless medium. Recognizing this as one of the tradeoffs between the physical size of a cellular telephone and the size of the cellular telephone's antenna has resulted in several antenna designs and after market add-ons to cellular telephones to boost the sensitivity of the antenna. Unless the cellular user is operating a cellular telephone near the end of a cellular service provided coverage area or in difficult to cellular reception areas such as inside elevators, the standard, albeit smaller, internal cellular telephone antennas perform satisfactory. The prospect of lugging around extra external antennas for occasional use is not a desirable alternative.

Accordingly, a need exists to solve the aforementioned drawbacks of the smaller cellular antenna sizes and to provide a system to the user to adjust the antenna size and attendant reception sensitivity based on a particular use.

### SUMMARY OF THE INVENTION

In accordance with an aspect of the present invention, a combination wireless device antenna and headset has a speaker and an audio conductor. The combination wireless device antenna and handset also has an audio input that is conductively coupled to the speaker through the audio conductor. The combination wireless device antenna and handset further has an RF connection and an RF antenna element that is coupled to the RF connection and that performs at least one of RF radiation and RF reception. The combination wireless device antenna and handset also has a retractor that positions at least a portion of the RF antenna element and at least a portion of the audio conductor from a first retracted length to a second extended length.

In accordance with another aspect of the present invention, a cellular phone with a retractable combination wireless device antenna and headset has a wireless receiver for receiving RF signals, a wireless transmitter for transmitting RF signals and an audio input/output circuit for processing audio signals. This cellular phone further has an audio conductor, a speaker that is conductively connected to the audio input/output circuit through the audio conductor and an RF antenna element that is coupled to the wireless receiver and the wireless transmitter. This cellular phone further has a retractor that positions at least a portion of the RF antenna element and at least a portion of the audio conductor from a first retracted length to a second extended length.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIGS. 1A-1D are diagrams of various embodiments a retractable hands-free headset and antenna for coupling with a wireless device, according to the present invention.

FIG. 2 is a top view of the retractor of FIG. 1 according to the present invention.

FIG. 3 is a block diagram of the relevant electronic portions of a portable wireless device FIG. 1, according to the present invention.

FIG. 4 is an illustration of the arrangement of exemplary operational environment for use with the wireless communication device of FIG. 3, according to the present invention.

FIG. 5 is a processing flow diagram for a diversity antenna operation according to one embodiment of the present invention.

### DESCRIPTION OF THE PREFERRED EMBODIMENTS

Overview

The present invention overcomes many of the problems with prior art external hands-free headsets and external antennas. The present invention improves hands-free capability of cellular telephones. The present invention incorporates the hands-free headset and external antenna into the cellular telephone that separates into two parts: one part for the receiving/transmitting antenna and another part being a headset with an ear piece and microphone. The external antenna along with the headset is incorporated into one cable. The cable assembly is stored in a retractor inside the cellular telephone.

The use of a common cable to house both an external antenna and headset that is retractable back into the cellular telephone safely stores the wires until further use. The present invention simplifies carrying external headsets and/or antennas, and alleviates the problems with the wires of the headsets becoming tangled, by storing all of the wires, antenna and headset as part of a retractor which is attached to or integrated in the cellular telephone.

Further, the present invention makes it easier for consumers and cellular telephone users to comply with local ordinances and laws that prohibit the use of cellular telephones without hands-free headsets while operating motor vehicles.

General:

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The cellular telephone, according to a preferred embodiment of the present invention, is part of a mobile radio transceiver that generally performs wireless communications with one of several neighboring, fixed location radio transceiver base stations. However, it should be obvious to those of ordinary skill in the art in view of the present discussion that any type of mobile wireless receiver device that receives communications from a plurality of transmitting stations will benefit from the advantages of the present invention.

Retractable Hands-Free Headset and Antenna

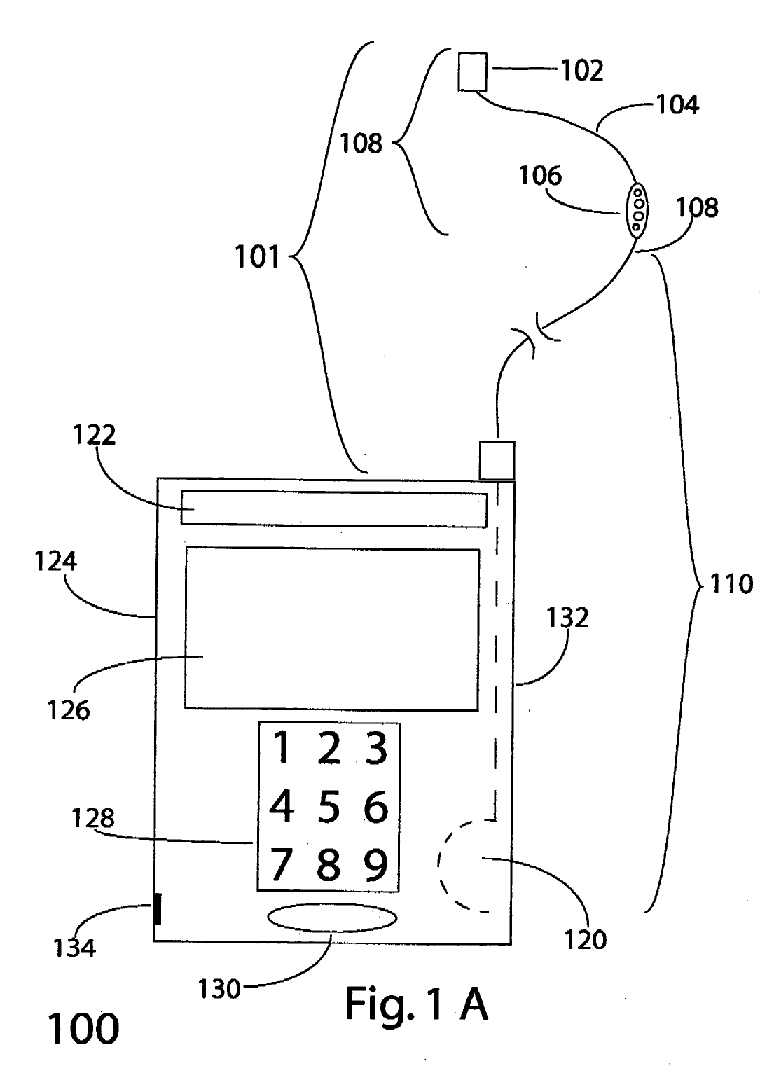

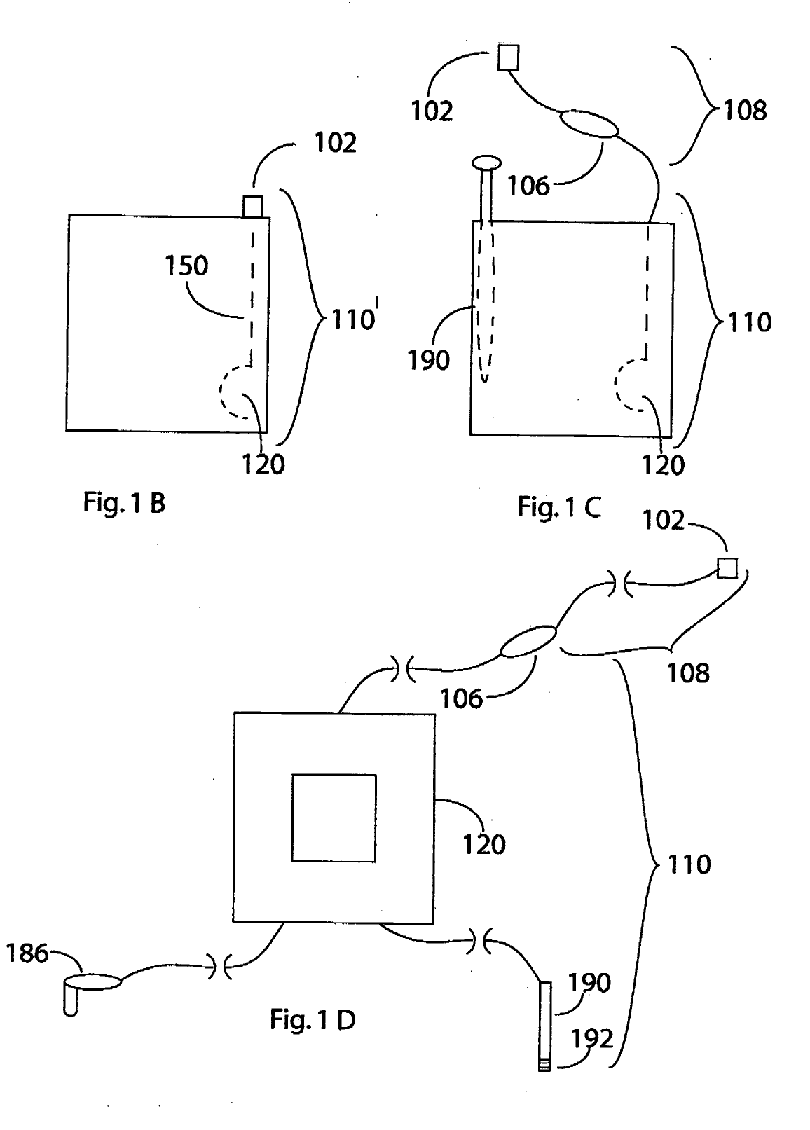

FIGS. 1A-1D are diagrams of various embodiments of a retractable hands-free headset and antenna for coupling with a wireless device, according to the present invention. Turning to FIG. 1A shown is an isometric view 100 of the wireless communication device with a retractable hands-free headset and antenna, internal to the wireless device, according to the present invention. A hands-free headset 108 includes a earpiece 102 attached by a cable 104 to a microphone 106. Many commercially available hands-free headsets with earbuds have been shown to be used advantageously adapted to the present invention including those available from Plantronics, Shure and others. A cable 108 attaches the headset 108 including the microphone 106, the headset cable 104 and the earbud 102.

The antenna 110 in the present invention can be a single extendable antenna of a first retracted length and a second extended length. In another embodiment, the antenna in the present invention is a diversity antenna as known to those of average skill in the art and is described further below. The antenna 110 along with the headset 108 share a common cable assembly 118 which is winds around retractor 120. Common cable assembly 118 in the exemplary embodiments include an audio conductor for conductively coupling the earbud 102, or other type of speaker, and optionally microphone 106 to an audio input that is part of the audio circuits of wireless device 124. The RF antenna 110 connects to RF connections that form electrical interfaces with RF circuits within the wireless device 124. Coupling between the RF circuits and the RF antenna 110 is able to be a conductive coupling or a reactive coupling that couples RF energy to the antenna 110 through capacitive coupling, inductive coupling, or a combination of inductive and capacitive coupling. A common conductor is able to be used for both an audio conductor and the extendable antenna element. The retractor 120 retracts or positioned at least the common cable assembly 118 and is any commercially available retractor such as those designed by ResTech Inc. of New Hampshire and those shown in U.S. Pat. No. 6,082,652 issued Jul. 4, 2000 entitled electronic device with retractable cord, which is hereby incorporated herein by reference in its entirety.

FIG. 1B illustrates the embodiment illustrated in FIG. 1A, wherein the retractor 120 is placed internally in the wireless device. FIG. 1B illustrates the single extendable antenna in the second extended length 110′, thereby forming the internal antenna 150 of the telephone. Conversely, when the retractor is extended the antenna 110 is formed external to the wireless device 124 as shown in FIG. 1A.

In yet other another embodiment, as shown in FIG. 1D, the retractor 120 is external to the wireless device 124. Audio conductors of this embodiment are connected through an external headset jack 134 via plug 186. An RF connection for this embodiment is formed by a threaded connector 192 that is part of an antenna extension 190. The external retractor 120 can be physically attached to a belt clip or the wireless device 124 through a variety of clips, slots, screws, fasteners and alike as know to those of average skill in the art.

In yet still another embodiment as shown in FIG. 1C, the extendable antenna connected to retractor 120 is used in conjunction with an internal antenna 140. In this embodiment, the antenna 110 is shown in the extended position. The antenna is able to be extended, as shown, to become the external headset 108 and external antenna 110.

In all the embodiments shown in FIGS. 1A-1D, the headset 108 and the antenna 110 in retractor 120 are attached to a wireless device such as a cellular telephone, two-way walkie-talkie, satellite telephone or other wireless messaging device 124. The wireless messaging device 124 includes a display 126, a keypad or other input device 128, an internal microphone 130, and internal speaker 122.

Retractor

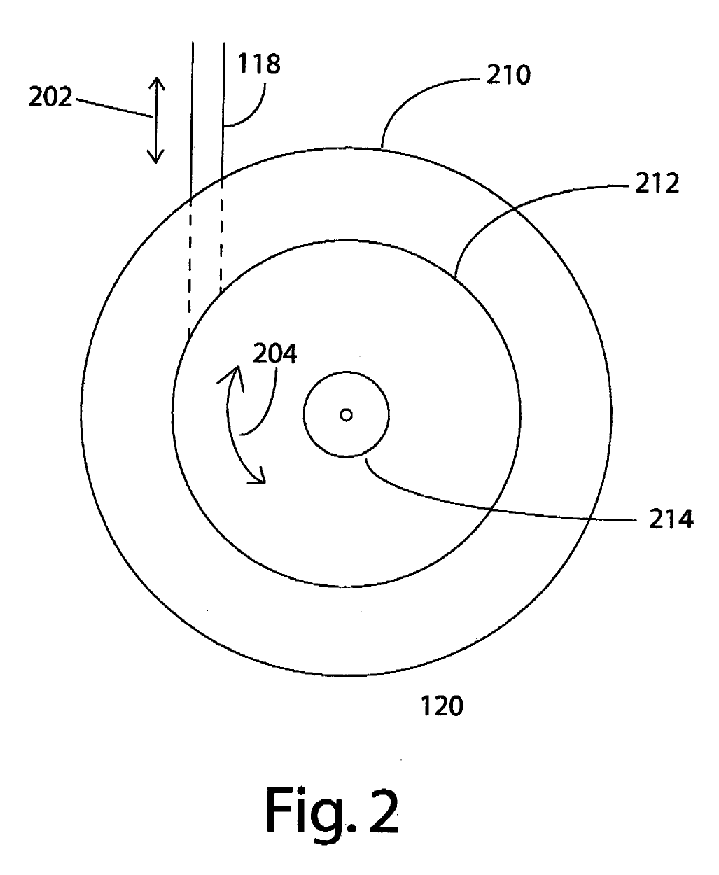

FIG. 2 is a top view of the retractor of FIG. 1 according to the present invention. The wire 118 from the antenna 110 and headset 108 pulls out linearly 202 from housing 210. A spindle in the housing 210 is mounted on a shaft 214 to rotate 204 so as to extend or retract the cable or wire 118 on the spool as known to those of average skill in the art. A spring actuated retraction mechanism includes a spring that urges the spindle to rewind and thereby retract the wire 118 back into the housing in a retracted position as shown in FIG. 1B. A stop (not shown) acts against the spring to hold the wire 118 at a fixed length extended away from the housing 110 in an extended position as shown in FIG. 1A.

Block Diagram of Wireless Communication Device

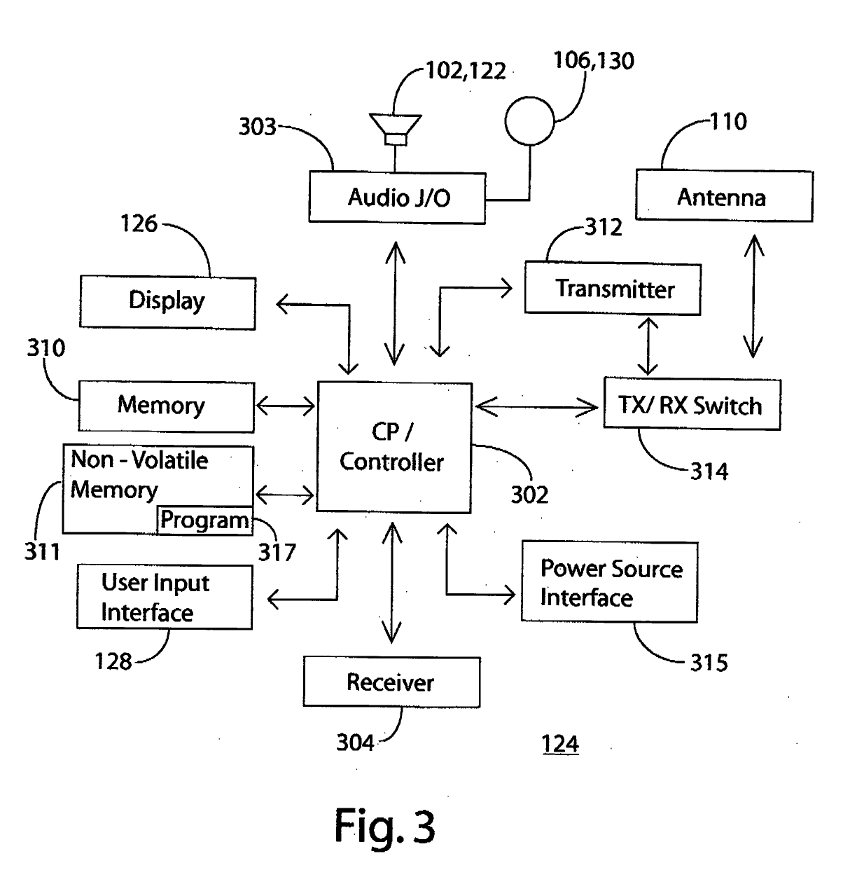

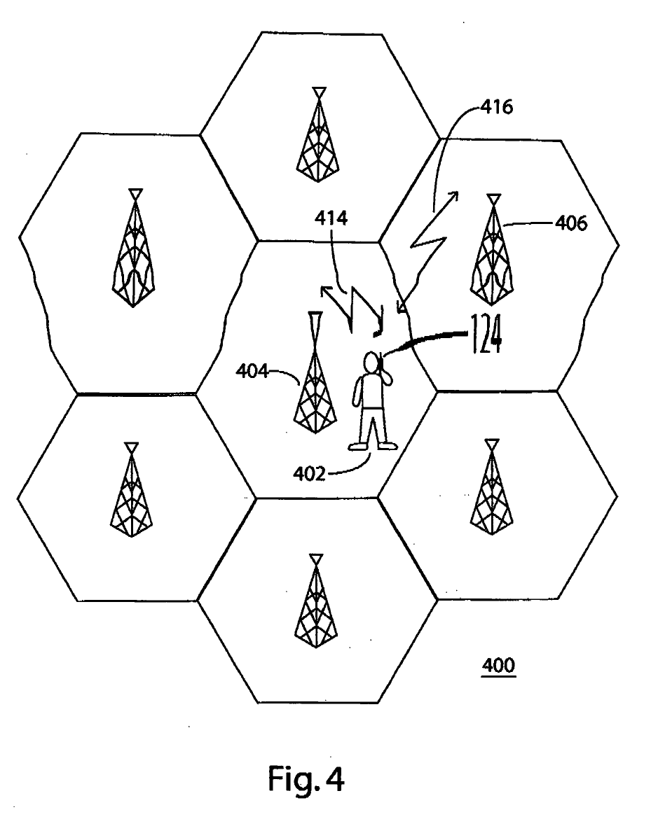

FIG. 3 is a block diagram of the relevant portions of a portable wireless device 124 of FIG. 1, according to the present invention. The wireless device 124 is any device with a display including a wireless telephone, PDA, computer, electronic organizer, and other messaging device, and an electronic timepiece. The wireless device 124 includes a controller 302, a memory 310, a non-volatile (program) memory 311 containing at least one application program 317 a power source such as a battery (not shown) through a power source interface 315. The application program 117 will be discussed in more detail below.

The wireless device 124 transmits and receives signals for enabling a wireless communication such as for a cellular telephone, in a manner well known to those of ordinary skill in the art. For example, when the wireless device 124 is in a “receive” mode, the controller 302 controls a radio frequency (RF) transmit/receive switch 114 that couples an RF signal from an antenna 110 through the RF transmit/receive (TX/RX) switch 314 to an RF receiver 304, in a manner well known to those of ordinary skill in the art. The RF receiver 304 receives, converts, and demodulates the RF signal, and then provides a baseband signal, for example, to audio output module 303 and a transducer 102, 130, such as speaker 120 (and earbud 122 when headset 108 is used), in the wireless device 124 to provide received audio to a user. The receive operational sequence is under control of the controller 302, in a manner well known to those of ordinary skill in the art.

In a “transmit” mode, the controller 302, for example responding to a detection of a user input (such as a user pressing a button or switch on a user interface 126 of the wireless device 124, controls the audio circuits and a microphone interface 130, (and microphone 106 when the headset 108 is used), and the RF transmit/receive switch 114 to couple audio signals received from a microphone through an microphone interface to transmitter circuits 112 and thereby the audio signals are modulated onto an RF signal and coupled to the antenna 116 through the RF TX/RX switch 114 to transmit a modulated RF signal into a wireless communication system (not shown). This transmit operation enables the user of the wireless device 124 to transmit, for example, audio communication into the wireless communication system in a manner well known to those of ordinary skill in the art. The controller 302 operates the RF transmitter 312, RF receiver 304, the RF TX/RX switch 314, and the associated audio circuits (not shown), according to instructions stored in the program memory 311.

Further, the controller 302 is communicatively coupled to a user input interface 126 (such as a key board, buttons, switches, and the like 128) for receiving user input from a user of the wireless device 124 It is important to note that the user input interface 128 in one embodiment is incorporated into the display 109 as “GUI (Graphical User Interface) Buttons” as known in the art. The user input interface 128 preferably comprises several keys (including function keys) for performing various functions in the wireless device 124. In another embodiment the user interface 128 includes a voice response system for providing and/or receiving responses from the device user. In still another embodiment, the user interface 128 includes one or more buttons used to generate a button press or a series of button presses such as received from a touch screen display or some other similar method of manual response initiated by the device user. The user input interface 107 couples data signals (to the controller 302) based on the keys depressed by the user. The controller 302 is responsive to the data signals thereby causing functions and features under control of the controller 302 to operate in the wireless device 124. The controller 302 is also communicatively coupled to a display 126 (such as a liquid crystal display) for displaying information to the user of the wireless device 124.

The present invention can be realized in hardware, software, or a combination of hardware and software. The present invention can also be embedded in a computer program product, which comprises all the features enabling the implementation of the methods described herein, and which—when loaded in the wireless device 124—is able to carry out these methods.

Operational Environment

FIG. 4 is an illustration of the arrangement of exemplary operational environment 400 for use with the wireless communication device of FIG. 3, according to the present invention. A user 402 has a portable wireless device 124 that is a cellular telephone transceiver that has a receiver, a transmitter and associated control circuitry. The wireless device 124 is able to communicate with any one of multiple neighboring base station transceivers within cellular base stations that are part of a cellular telephone land mobile network and that are within wireless communication range of the wireless device 124. The exemplary operational environment 400 shows two base station transceivers, a far base station transceiver 406 and a near base station transceiver 404. Signals are wirelessly communicated between the wireless device 124 and the far base transceiver 406 over long wireless link 416. Signals are similarly communicated between the wireless device 124 and the near base transceiver 104 over short wireless link 114. In actual operation of the exemplary embodiment, many neighboring base station transceivers are frequently located sufficiently close to the wireless device 124 to support effective communications. The base station transceivers in this exemplary embodiment are shown as fixed for ease of understanding but this is not a requirement as is discussed below. The operation of the exemplary embodiment is more clearly understood by reference to the transmission function of the base transceivers and the receiving functions of the wireless device 124. It is understood that both the base station transceivers and the wireless device 124 in this exemplary embodiment include transmitting and receiving functions, although they are not required for the operation of these embodiments.

In the configuration of the exemplary operational environment 400, the more effective wireless communications between the wireless device 124 and a base station uses the short wireless link 414 to communicate with the near base transceiver 404. The wireless device 124 therefore selects to communicate with the near base transceiver 404 by the techniques of the conventional protocol used by the wireless systems known to average skill in the art. The more effective wireless communications in this example is due to the reduced transmission losses associated with the short wireless link 414 as compared to the long wireless link 416. In practice, the shortest link may not give the best Carrier to Interference (C/I) ratio at the wireless device 124, due to fading and large buildings or other structures in the line of sight between the mobile transceiver and base station. The “short wireless link” 414 is used in this description for simplicity of explanation and understanding.

The wireless device 124 of the exemplary embodiment determines the best base transceiver to use for communications by noting that the received wireless signal that corresponds to the signal transmitted by the near base transceiver 404 has higher quality than the received wireless signal that corresponds to the signal transmitted by the far base transceiver 406. The wireless device 124 continues to monitor transmissions from neighboring base station transceivers, such as from the near base transceiver 404 and far base transceiver 406, to determine which received signal has the highest quality and therefore which base transceiver to select for the most effective two-way communications.

Antenna Selection

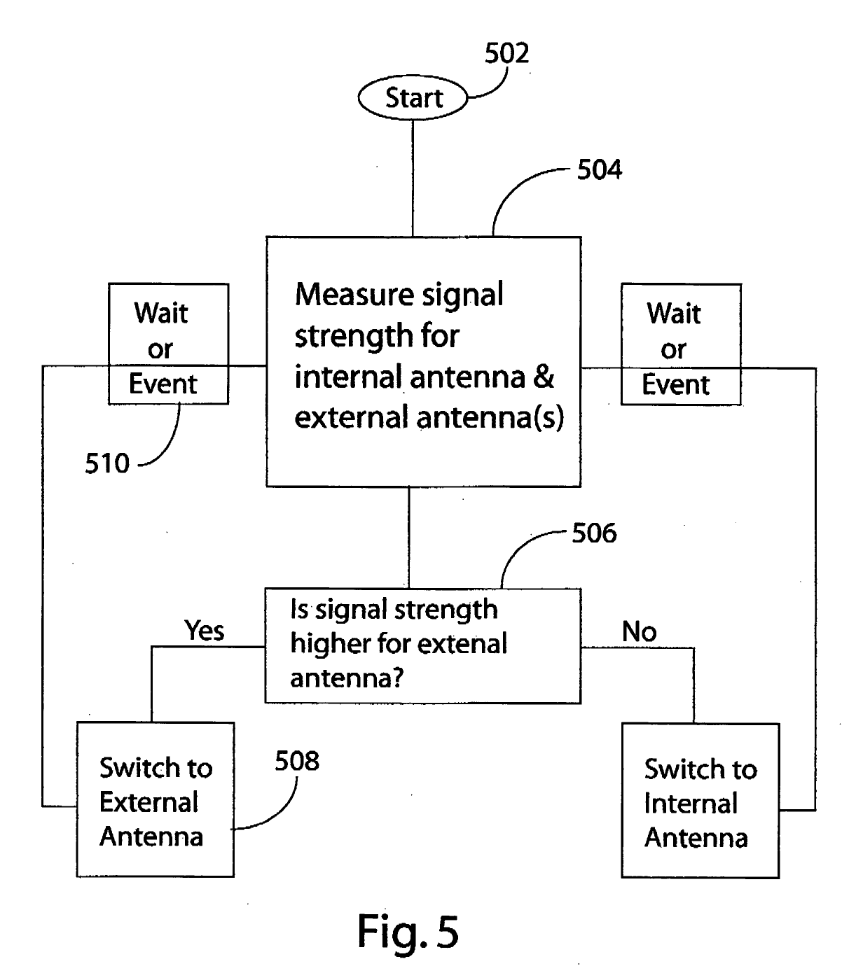

FIG. 5 is a processing flow diagram for a diversity antenna operation according to one embodiment of the present invention. This embodiment includes a diversity switching circuit that includes RF circuits and controller/data processing circuits to implement the processing described herein to selectively connect one of two or more antennas to an RF connection based upon observed signal strength on each of the two or more antennas. When the combined package 101 of the hands-free headset 108 and antenna 110 is in the extended position, the antenna strength many times will be significantly stronger. The process flow with is embodied in one embodiment as a program 317 in the wireless device 124 is now described. The process begins in step 502 and measurements of signal strength are made for the internal antenna and the external antenna in step 504. Next in step 506 a comparison is made to determine which signal strength is greater. If the external signal strength is greater, the external antenna is selected through step 508 and a switch (not shown) in wireless device 124. The process continues for a predetermined period of time before or until an event is sensed, such as end of call, or retraction of antenna 110 assembly, before the process returns to measuring in step 504. If on the other hand, the internal antenna has higher signal strength, the process flow from step 506 to step 512 to switch to the internal antenna. Again, the process continues for a predetermined period of time before or until an event is sensed, such as end of call, or retraction of antenna 110 assembly, before the process returns to measuring in step 504. It is important to note that the above process is exemplary only for a simple two-antenna system. More sophisticated algorithms for determining signal strength are within the true scope and spirit of the present invention including U.S. Pat. No. 6,240,301 with inventor John C Phillips entitled “Entitled Diversity antenna in a SIM card package” issued on May 29, 2001 and U.S. Pat. No. 5,392,054 with inventor Gregory E. Bottomley and Edward Smith entitled “Diversity antenna assembly for portable radiotelephones issued on Feb. 21, 1995, each of which is hereby incorporated by reference in their entirety.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

1. A combination wireless device antenna and headset, comprising:
a speaker;
an audio conductor;
an audio input, conductively coupled to the speaker through the audio conductor;
an RF connection;
an RF antenna element, coupled to the RF connection, that performs at least one of RF radiation and RF reception; and
a retractor that positions at least a portion of the RF antenna element and at least a portion of the audio conductor from a first retracted length to a second extended length.

2. The combination wireless device antenna and headset according to claim 1, wherein the RF connection is coupled to the RF antenna element by one of conductive coupling and reactive coupling.

3. The combination wireless device antenna and headset according to claim 1, further comprising:
a microphone; and
a microphone interface, conductively coupled to the microphone.

4. The combination wireless device antenna and headset according to claim 1, wherein at least a portion of the audio conductor comprises at least a portion of the RF antenna element.

5. The combination wireless device antenna and headset according to claim 1, the retractor comprising a spring actuated retraction mechanism.

6. The combination wireless device antenna and headset according to claim 1, further comprising:
an alternate RF antenna; and
a diversity switching circuit that selectively connects one of the RF antenna element and the alternate RF antenna to the RF connection based upon observed signal strength on the RF antenna element and the alternate antenna.

7. The combination wireless device antenna and headset according to claim 1, wherein the alternate RF antenna is a primary internal antenna.

8. A cellular phone with a retractable combination wireless device antenna and headset, comprising:
a wireless receiver that receives RF signals;
a wireless transmitter that transmits RF signals;
an audio input/output circuit that processes audio signals;
an audio conductor;
a speaker conductively connected to the audio input/output circuit through the audio conductor;
an RF antenna element, coupled to the wireless receiver and the wireless transmitter; and
a retractor that positions at least a portion of the RF antenna element and at least a portion of the audio conductor from a first retracted length to a second extended length.

9. The cellular phone according to claim 8, further comprising a microphone that is conductively coupled to the audio input/output circuit.
